(19) United States
(12) Patent Application Publication
(10) Pub. No.: US 2026/0360066 A1
(43) Pub. Date: Nov. 12, 2026

(54) TUNING-FREE VIDEO GENERATION USING SYNCHRONIZED COUPLED SAMPLING

(71) Applicant: Adobe Inc., San Jose, CA (US)

(72) Inventors: Seoungwug OH, San Jose, CA (US); Subin KIM, Gumi-si (KR); Jui-Hsien WANG, Sammamish, WA (US); Joon-Young LEE, San Jose, CA (US)

(21) Appl. No.: 19/205,342

(22) Filed: May 12, 2025

(51) Int. Cl. G06T 13/80; G06T 5/50; G06T 5/60; G06T 5/70; G06V 10/74; G06V 10/774; G06V 20/40

(52) U.S. Cl. CPC G06T 13/80; G06T 5/50; G06T 5/60; G06T 5/70; G06V 10/761; G06V 10/774; G06V 20/49; G06T 2207/10016; G06T 2207/20081; G06T 2207/20084

(57) ABSTRACT

In some aspects, a processing device may receive one or more text prompts. The processing device may receive an input video associated with the one or more text prompts. The processing device may perform, using a machine learning model, one or more forward diffusion operations on the input video to generate an intermediate output based on the one or more text prompts associated with the input video and similarities among one or more segments of the input video. The processing device may perform, using the machine learning model, a reverse diffusion operation on the intermediate output to generate an output video associated with the one or more text prompts.

### BACKGROUND

Diffusion models are generative machine learning (or artificial intelligence) models that have demonstrated significant success in various visual applications, such as image synthesis and video generation, and in other areas such as audio generation, text generation, and bioinformatics. In particular, diffusion models can be trained to iteratively transform an initial noise distribution (e.g., Gaussian noise) into a complex real-world data distribution, such as images, videos, or associated encodings. Accordingly, diffusion models have applications across various domains due to their ability to generate high-quality, diverse, and realistic data outputs.

### SUMMARY

According to some aspects described herein, a diffusion model (e.g., a text-to-video diffusion model) implements a coupled sampling framework to synchronize a denoising process across adjacent video segments and non-adjacent video segments, such that a video that the diffusion model generates from an input prompt has global temporal consistency (e.g., coherent content and semantics across the entire video). For example, in some aspects, the diffusion model may implement an iterative denoising process that couples denoising diffusion implicit model (DDIM) sampling and collaborative score distillation (CSD) sampling to gradually transform noise into a video with diverse changes controlled or guided by the input prompt, seamless and smooth transitions, and long-term contextual consistency throughout the video.

For example, in each iteration, the denoising process includes a DDIM update in which an input video to be denoised is divided into overlapping segments that are each associated with guidance based on the input prompt. In each DDIM update, diffusion forward is performed to denoise each segment individually, the denoised segments are fused to form an intermediate output, and the intermediate output is reverted to a previous timestep. Furthermore, in one or more iterations (e.g., until a time when a coherent semantic layout is established between video segments), the denoising process includes a CSD optimization that builds upon the intermediate output from the DDIM update to establish further consistency across the entire video (e.g., between adjacent and non-adjacent segments). For example, in the iteration(s) where the CSD optimization is performed, the intermediate output from the DDIM update is divided into overlapping segments, and a score is calculated for one or more sampled segments based on an inter-sample affinity or inter-sample consistency (e.g., more similar samples exchange more score updates, and dissimilar samples interchange score information less often). The overlapping segments are then fused again, based on updated gradients that are synchronized across the sampled segments, to form a refined intermediate output.

In this way, by combining scores across segments, the coupled DDIM and CSD sampling framework can effectively handle cases where the input prompt introduces divergent denoising paths. For example, despite any potential divergence between denoising paths, the CSD optimization that is performed during the DDIM update in one or more denoising iterations aligns denoising levels and synchronously updates scores across video segments, which minimizes content or style drift and preserves global semantic consistency throughout the video.

Aspects described herein generally include a method, a system, a device, a non-transitory computer-readable medium, and/or an apparatus, as substantially described herein with reference to and as illustrated by the drawings and specification.

The foregoing has broadly outlined the features and technical advantages of examples described herein such that that the detailed description that follows may be better understood. Additional features and advantages will be described hereinafter. The conception and specific examples described herein may be readily utilized as a basis to modify or design other aspects for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purposes of illustration and description, and not as a definition of the limits of the claims.

### BRIEF DESCRIPTION OF THE DRAWINGS

FIG. 1 illustrates an example associated with tuning-free video generation using synchronized coupled sampling, according to some aspects of the present disclosure.

FIG. 2 illustrates an example guided diffusion model, according to some aspects of the present disclosure.

FIG. 3 illustrates an example U-Net, according to some aspects of the present disclosure.

FIG. 4 illustrates an example method for conditional media generation, according to some aspects of the present disclosure.

FIG. 5 illustrates an example diffusion process, according to some aspects of the present disclosure.

FIG. 6 is a flow diagram illustrating an example procedure for training a machine learning model, according to some aspects of the present disclosure.

FIG. 7 illustrates an example method for training a diffusion model, according to some aspects of the present disclosure.

FIG. 8 illustrates an example associated with tuning-free video generation using synchronized coupled sampling, according to some aspects of the present disclosure.

FIG. 9 illustrates an example associated with tuning-free video generation using synchronized coupled sampling, according to some aspects of the present disclosure.

FIG. 10 illustrates an example environment associated with tuning-free video generation using synchronized coupled sampling, according to some aspects of the present disclosure.

FIG. 11 illustrates an example process associated with tuning-free video generation using synchronized coupled sampling, according to some aspects of the present disclosure.

FIG. 12 illustrates an example process associated with tuning-free video generation using synchronized coupled sampling, according to some aspects of the present disclosure.

FIG. 13 illustrates an example device associated with tuning-free video generation using synchronized coupled sampling, according to some aspects of the present disclosure.

FIG. 14 illustrates an example video generation apparatus, according to some aspects of the present disclosure.

### DETAILED DESCRIPTION

As described herein, diffusion models are generative models that learn to gradually transform a noise sample from a noise distribution toward a target data distribution. The transformation generally includes a forward process, or forward diffusion process, in which noise is incrementally added to a data sample over a sequence of timesteps, leading to a gradual loss of structure in the data. The reverse diffusion process inverts the forward diffusion process, gradually removing the noise and recovering the original target data distribution. The reverse transformation is modeled using a diffusion model trained using a loss function based on denoising score matching. Accordingly, a diffusion model can generate new data with features that are similar to features found in the training data. For example, in some cases, text-to-video (T2V) diffusion models have capabilities to synthesize high-quality video from a text prompt. However, existing T2V diffusion models are limited to generating relatively short video clips (e.g., about 5 to 10 seconds in length) due to high computational costs during training, which restricts how many frames can be processed during training such that T2V diffusion models are restricted to short video clips during inferencing. Furthermore, techniques to extend T2V diffusion models to generate longer videos suffer from various drawbacks.

For example, although a transformer-based architecture can be trained from scratch to generate one-shot long videos from multiple prompts, transformer-based architectures often suffer from poor quality and content drift despite the extensive training. In another example, diffusion models with autoregressive modeling use conditioning techniques to enable auto-regressive video generation. However, diffusion models with autoregressive modeling suffer from accumulated errors, which leads to inconsistent and low-quality artifacts in the final output. Furthermore, diffusion models with autoregressive modeling only generate videos from a single prompt that cannot fully describe diverse changes that occur during a long video (e.g., varied object motions, camera viewpoint changes, or background and style changes). As a result, extended long videos that are generated using autoregressive modeling often have tediously repeated motions and reduced scene dynamics that can be expressed using multiple prompts. In another technique, a set of frames can be generated in a hierarchical manner and then interpolated. However, only a limited number of keyframes generated at once, and interpolating between the keyframes does not introduce new content or significant dynamics. Further, efforts to generate long videos using diffusion models without extensive training on large datasets (that are hard to collect) typically focus on smooth local transitions between frames, which results in drift in content and/or semantics across the video due to the lack of global synchronization.

Accordingly, some aspects described herein relate to a synchronized coupled sampling framework implemented in a diffusion model (e.g., a T2V diffusion model) to synchronize a denoising process across adjacent video segments and non-adjacent video segments, such that a video that the diffusion model generates from an input prompt has global temporal consistency (e.g., coherent content and semantics across the entire video). For example, in some aspects, the coupled sampling framework is implemented in connection with an iterative denoising process, where denoising updates use denoising diffusion implicit model (DDIM) sampling in combination with collaborative score distillation (CSD) sampling to gradually transform noise into a video with diverse changes controlled or guided by the input prompt, seamless and smooth transitions, and long-term contextual consistency throughout the video. For example, in each iteration, the denoising process includes a DDIM update in which an input video to be denoised is divided into overlapping segments that are each associated with guidance based on the input prompt. In each DDIM update, diffusion forward is performed to denoise each segment individually, the denoised segments are fused to form an intermediate output, and the intermediate output is reverted to a previous timestep. Furthermore, in one or more iterations (e.g., until a time when a coherent semantic layout is established between video segments), the denoising process includes a CSD optimization that builds upon the intermediate output from the DDIM update to establish further consistency across the entire video (e.g., between adjacent and non-adjacent segments). For example, in the iteration(s) where the CSD optimization is performed, the intermediate output from the DDIM update is divided into overlapping segments, and a score is calculated for sampled segments based on an inter-sample affinity or inter-sample consistency. For example, more similar samples exchange score updates more often, and dissimilar samples exchange score updates less often, such that the CSD optimization increases similarities or consistency among a batch of samples. The overlapping segments are then fused again, based on updated gradients that are synchronized across the sampled segments, to form a refined intermediate output. In addition, the input prompt to the diffusion model may be structured to divide a comprehensive story or scenario into multiple prompts that control the video generation. For example, an input prompt may include or may be parsed and divided into a structure that includes a global prompt that describes shared properties across the entire video, and one or more local prompts that specify dynamic changes such as object movements, motions, or style changes.

In this way, by combining scores across segments, the coupled DDIM and CSD sampling framework can effectively handle cases where the input prompt introduces divergent denoising paths. For example, despite any potential divergence between denoising paths, the CSD optimization that is performed during the DDIM update in one or more denoising iterations aligns denoising levels and synchronously updates scores across video segments, which minimizes content or style drift and preserves global semantic consistency throughout the video. Furthermore, by performing the CSD optimization on the intermediate output during the DDIM update, with denoising for each video segment guided by a global prompt that describes an overall context and a local prompt that defines dynamic changes within the segment, the CSD optimization has structured inputs that are used during synchronization to achieve global synchronization across video segments and seamless transitions between frames. Furthermore, the CSD optimization uses a fixed baseline noise, with optimization for each segment using a respective portion of the baseline noise, and a fixed timestep, which reduces variance that otherwise occurs when random noise sampling and random timestep selection are used at each optimization step. In addition, performing the CSD optimization on only on a subset of the segments in the fused intermediate output and only in a subset of the iterations of the denoising operation significantly reduces computational costs, such as processor and memory usage.

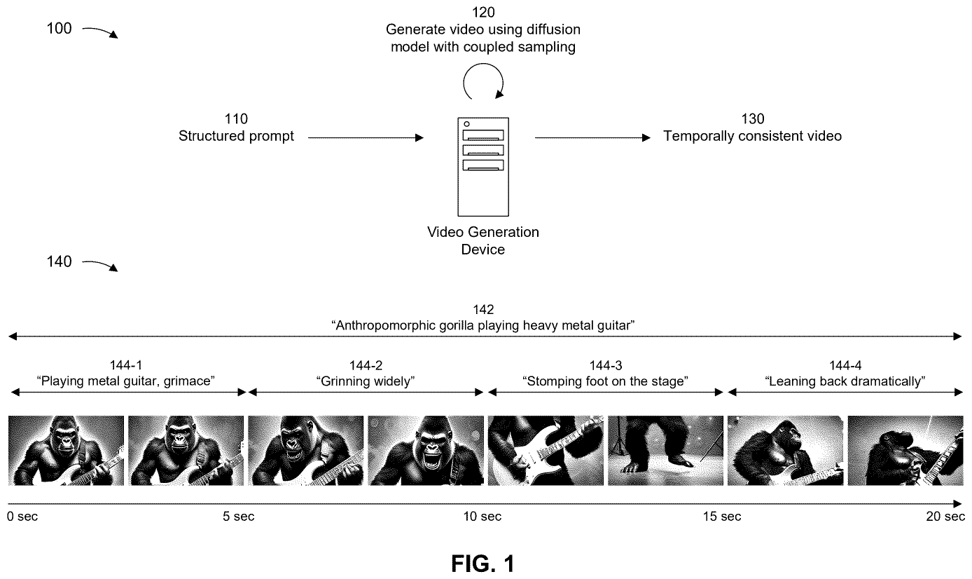

FIG. 1 illustrates an example 100 associated with tuning-free video generation using synchronized coupled sampling, according to some aspects of the present disclosure. As shown in FIG. 1, a video generation device executes an application or supports an application that can use a diffusion model to generate a video (e.g., longer than ten seconds) that has globally consistent semantics, seamless transitions between frames, and dynamic changes during the video, based on an input prompt, such as a text prompt or other guidance for generating the video. In some aspects, the video generation device may be a user device that executes the application, a server that executes the application and provides a user interface for interacting with the user device, or a server that performs processing tasks to provide computational resources to support the application executing on the user device, among other examples.

As shown by reference number 110, the video generation device may receive a structured prompt that provides guidance for generating a video. For example, in some aspects, a user may provide one or more input prompts to describe a comprehensive story or scenario, and the one or more input prompts may be structured to include a global prompt that describes shared properties across the entire video and one or more local prompts that specify dynamic changes, such as object appearances, styles, motions, camera viewpoint changes, actions, or descriptive adjectives, among other examples. Accordingly, the global prompt provides guidance to the diffusion model to ensure a consistent description of shared properties across the entire video, and respective local prompts provide guidance that build on the global prompt to incorporate dynamic controls for shorter segments within the video. For example, in some aspects, the one or more input prompts received from the user may be provided to a large language model (LLM) to generate the structured prompt. For example, the LLM may be configured to segment a story or scenario described in one or more input prompts into a global prompt that describes one or more properties that are shared across all local prompts, and one or more self-contained local prompts (e.g., containing a subject, a verb, and background information). The LLM may be configured to generate the global prompt to provide a detailed and concise description for the shared properties to avoid vagueness and enhance clarity and context for the local prompts.

Accordingly, as shown by reference number 120, the video generation device may use the diffusion model associated with the synchronized coupled sampling framework to generate a video based on the structured prompt. For example, in some aspects, the diffusion model uses classifier-free guidance (CFG) to generate the video conditioned on the text provided in the global prompt and the one or more local prompts, which linearly combines conditional and unconditional outputs with a guidance scale to modify denoising model predictions. For example, as described herein, the diffusion model is configured to generate a video with one or more segments, with guidance for each segment given by the global prompt and a respective local prompt. In this way, the structured prompt provides a comprehensive context to maintain semantic or content consistency across video segments during a reverse diffusion (denoising) process. For example, when a user provides a first prompt (e.g., “a teddy bear is standing”) and a second prompt (e.g., “a teddy bear is running”) that could result in generating divergent video segments (e.g., due to the shared term “teddy bear”), the global prompt (e.g., “a brown teddy bear with button eyes and a stitched smile”) reduces ambiguity and ensures consistency across video segments, and the local prompts provide additional context building on the global prompt.

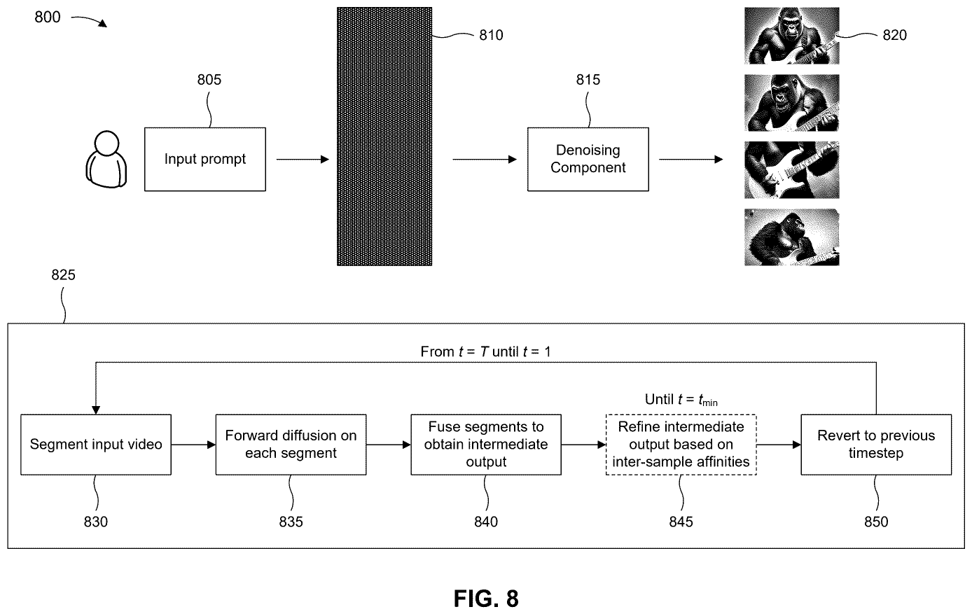

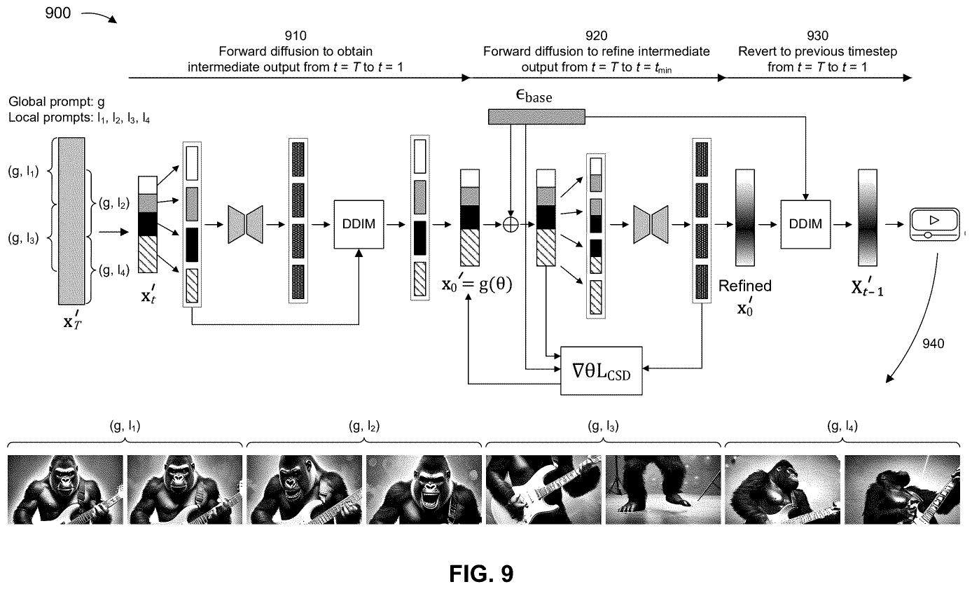

In some aspects, to generate the video based on the structured prompt, the diffusion model uses a reverse diffusion process that iteratively reverses a noise-adding process to gradually transform noise (e.g., Gaussian noise or random noise) into data, which is the video to be generated from the structured input prompt in the aspects described herein. The reverse diffusion (or denoising) process couples DDIM sampling, which leverages a non-Markovian approach to maintain a marginal distribution and reduce the number of sampling steps, with CSD sampling to increase inter-sample consistency across adjacent segments and non-adjacent (e.g., distant) samples. For example, the denoising process is performed in multiple iterations that each operate on an input video associated with the structured prompt to generate an output video in which the input video has been at least partially denoised. The denoising process uses the synchronized coupled sampling framework, where DDIM sampling is coupled with CSD sampling, to achieve overall temporal consistency across the entire video and ensure high-quality video generation. For example, as described in further detail herein with reference to FIG. 8 and FIG. 9, each iteration in the denoising process may include a DDIM update to generate an intermediate output video that is a denoised version of the input video. In one or more iterations, the denoising process intervenes in the DDIM update, and performs a CSD optimization performed in which the intermediate output video produced in the DDIM update is treated as a set of trainable parameters. For example, the CSD optimization refines the intermediate output video to establish further consistency between different segments (e.g., adjacent and non-adjacent segments). In the iterations where the CSD optimization is performed, the DDIM update is then resumed to revert the refined intermediate output video to a previous timestep. Alternatively, in the iterations where the CSD optimization is not performed (e.g., after a consistent semantic layout has been established across the entire video), the intermediate output video produced by the DDIM update is reverted to the previous timestep.

As shown by reference number 130, the video generation device may output, using the diffusion model, a temporally consistent video, with the structured prompt and coupled DDIM and CSD sampling providing semantic consistency across the entire video, dynamic controls in different segments within the video, and seamless transitions between frames. The denoising process starts from noisy data x′ₜ, and each iteration reverts a sample x′ₜ to a previous timestep, x′ₜ₋₁, with the denoising process performed iteratively from t=T until t=0 and the CSD optimization performed in iterations from t=T until t=tₘᵢₙ, where tₘᵢₙ has a configurable value based on the number of iterations to establish a consistent semantic layout.

Accordingly, FIG. 1 illustrates an example temporally consistent video 140 that the diffusion generates based on the synchronized coupled sampling framework. For example, as shown, the video 140 is associated with a global prompt 142 (“Anthropomorphic gorilla playing heavy metal guitar”) that describes shared properties applicable across the entire video. In addition, the video 140 includes multiple segments that are each generated with guidance based on the global prompt and a respective local prompt. For example, the video 140 includes a first segment guided by the global prompt 142 and a first local prompt 144-1, a second segment guided by the global prompt 142 and a second local prompt 144-2, a third segment guided by the global prompt 142 and a third local prompt 144-3, and a fourth segment guided by the global prompt 142 and a fourth local prompt 144-4. In some examples, the diffusion model can be used to generate videos that include more or fewer segments than shown in FIG. 1 and/or to generate videos that include segments with a shorter duration or a longer duration than shown in FIG. 1 (e.g., where each segment is 5 seconds or about 5 seconds). As shown, the synchronized coupled sampling framework results in the output video 140 including diverse changes controlled by the global prompt 142 and the respective local prompts 144, with seamless transitions between adjacent frames or segments, and long-term temporal consistency across the entire video.

As indicated above, FIG. 1 is provided as an example. Other examples may differ from what is described with regard to FIG. 1.

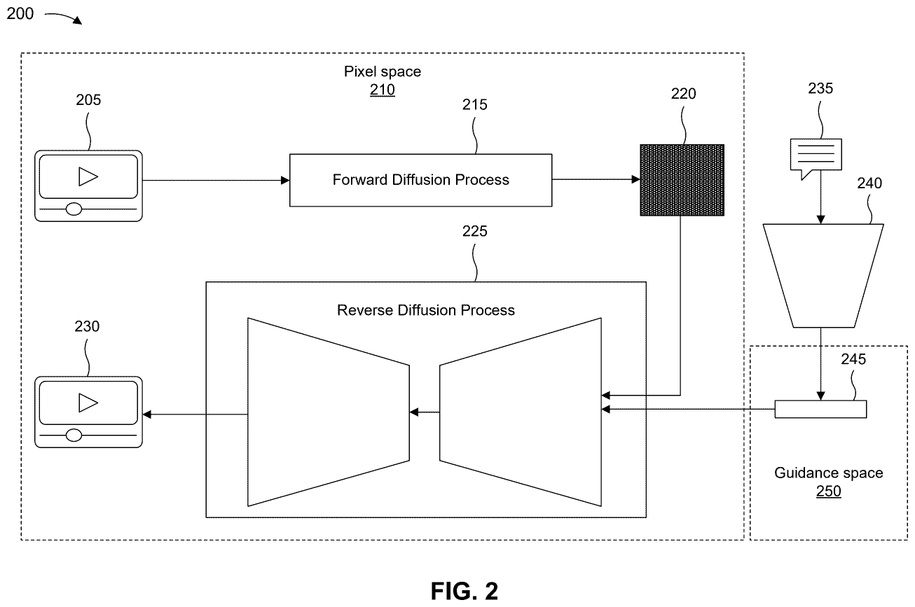

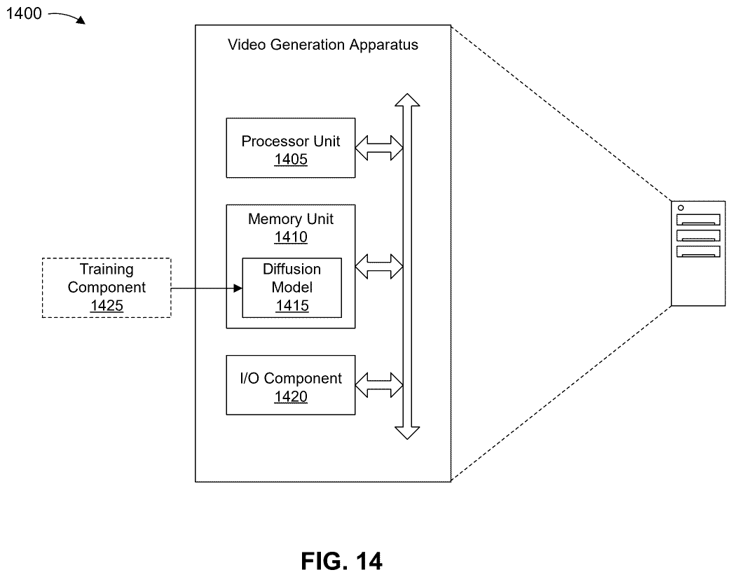

FIG. 2 illustrates an example guided diffusion model 200, according to some aspects of the present disclosure. In some examples, the guided diffusion model 200 describes the operation, architecture, and/or other aspects associated with the video generation device shown in and described herein with reference to FIG. 1 and/or the diffusion model 1415 shown in and described herein with reference to FIG. 14. In some examples, the guided diffusion model 200 depicted in FIG. 2 is an example of, includes, and/or or implements one or more aspects of a media generation model, such as a text-to-video diffusion model or another suitable model, that supports tuning-free video generation using synchronized coupled sampling, as described herein.

As described herein, diffusion models are a class of generative neural networks that can be trained to generate new data with features similar to features found in training data. In particular, diffusion models can be used to generate media items such as images, videos, audio files, 3D models, or other digital media items. Diffusion models can be used for various media processing tasks including image super-resolution, generating media items with perceptual metrics, conditional generation (e.g., generation based on an input prompt that provides text-based guidance or image-based guidance), image inpainting, and/or media manipulation.

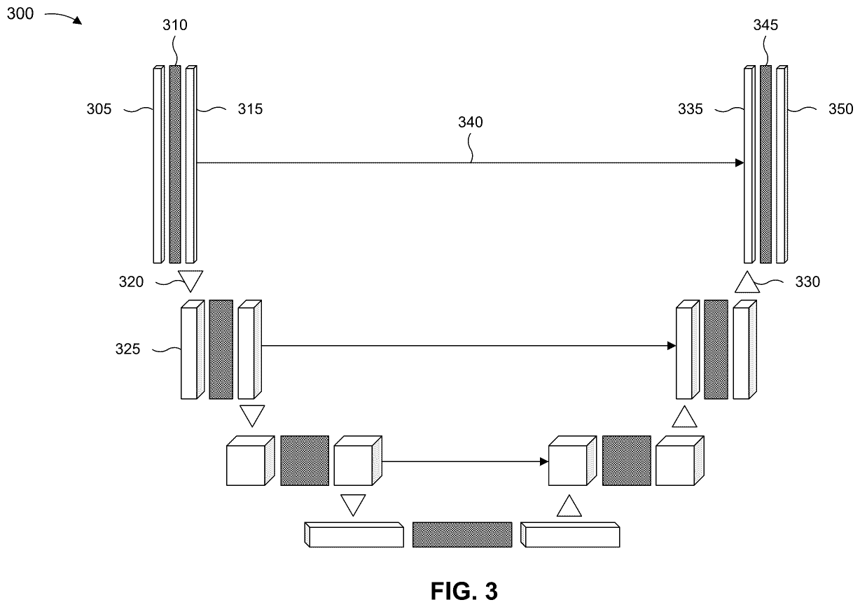

Diffusion models work by iteratively adding noise to a data sample during a forward diffusion process and then learning to recover the data sample by denoising the data sample during a reverse diffusion process. For example, during training, the guided diffusion model 200 may receive an original media item 205 in a pixel space 210 as an input and apply a forward diffusion process 215 to gradually add noise to the original media item 205 to obtain a noisy media item 220 at various noise levels. Next, a reverse diffusion process 225 (e.g., a U-Net, as described in further detail with reference to FIG. 3) gradually removes the noise from the noisy media item 220 at the various noise levels to obtain an output media item 230. In some cases, an output media item 230 is created from each of the various noise levels. The output media item 230 can be compared to the original media item 205 to train the reverse diffusion process 225.

In some examples, the reverse diffusion process 225 can be guided based on an input prompt 235, such as a text prompt, an image prompt, a layout, a segmentation map, or another suitable guidance prompt. The input prompt 235 can be encoded using an encoder 240 (e.g., a text encoder, a multimodal encoder, or another suitable encoder) to obtain guidance features 245 in a guidance space 250. The guidance features 245 can be combined with the noisy media item 220 at one or more layers of the reverse diffusion process 225 to ensure that the output media item 230 includes content described by the input prompt 235. For example, the guidance features 245 can be combined with the noisy features using a cross-attention block within the reverse diffusion process 225.

In some examples, methods to operate diffusion models, such as the guided diffusion model 200, include denoising diffusion probabilistic models (DDPM) and denoising diffusion implicit models (DDIM). In DDPM, the generative process includes reversing a stochastic Markov diffusion process. In DDIM, the generative process uses a deterministic process such that the same input results in the same output. In some cases, DDIM can reduce the number of timesteps during media generation. Diffusion models may also be characterized by whether the noise is added to the media item (e.g., media item 205), or to media features (e.g., guidance features 245) generated by an encoder (e.g., via latent diffusion). In a pixel diffusion model, noise is added and removed in a pixel space, such as pixel space 210. In a latent diffusion model, the noise is added (and removed) in a latent space of media features rather than in a pixel space. Accordingly, a latent diffusion model generates media features using reverse diffusion, and the media features can be decoded to obtain a synthetic media item.

As indicated above, FIG. 2 is provided as an example. Other examples may differ from what is described with regard to FIG. 2.

FIG. 3 illustrates an example U-Net 300, according to some aspects of the present disclosure. In some examples, the U-Net 300 is an example component that performs the reverse diffusion process 225 of the guided diffusion model 200 described with reference to FIG. 2 and includes architectural elements of the diffusion model 1415 described with reference to FIG. 14. The U-Net 300 depicted in FIG. 3 is an example of, or includes or implements aspects of, the architecture used within the reverse diffusion process 225 described with reference to FIG. 2.

In some examples, diffusion models are based on a neural network architecture known as a U-Net. The U-Net 300 takes input features 305 having an initial resolution and an initial number of channels and processes the input features 305 using an initial neural network layer 310 (e.g., a convolutional network layer) to produce intermediate features 315. The intermediate features 315 are then down-sampled using a down-sampling layer 320 to generate down-sampled features 325 that have a resolution that is lower than an initial resolution of the intermediate features 315 and a number of channels that is greater than an initial number of channels of the intermediate features 315.

In some examples, the process of generating intermediate features and then generating down-sampled features is repeated multiple times, and then the process is reversed. For example, the down-sampled features 325 are up-sampled using an up-sampling layer 330 to obtain up-sampled features 335. The up-sampled features 335 can be combined with intermediate features 315 having the same resolution and the same number of channels via a skip connection 340. The inputs (e.g., the up-sampled features 335, alone or combined with the intermediate features 315 with the same resolution and number of channels) are processed using a final neural network layer 345 to produce output features 350. In some examples, the output features 350 have the same resolution as the initial resolution of the input features 305 and the same number of channels as the initial number of channels of the input features 305.

In some cases, the U-Net 300 takes additional input features to produce conditionally generated output. For example, the additional input features may include a vector representation of an input prompt. The additional input features can be combined with the intermediate features 315 within the neural network at one or more layers. For example, a cross-attention module can be used to combine the additional input features and the intermediate features 315.

As indicated above, FIG. 3 is provided as an example. Other examples may differ from what is described with regard to FIG. 3.

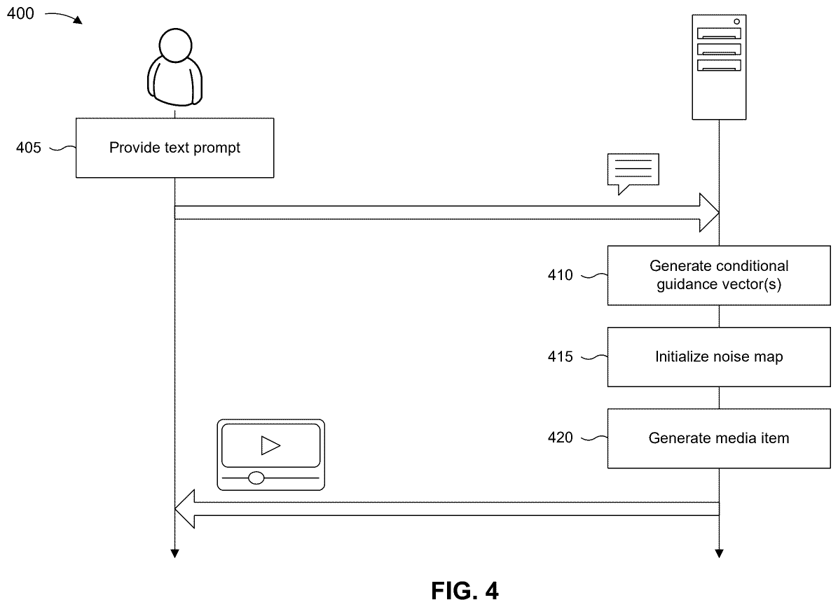

FIG. 4 illustrates an example method 400 for conditional media generation, according to some aspects of the present disclosure. In some examples, the method 400 describes an operation of the diffusion model 1415 described with reference to FIG. 14, such as an application of the guided diffusion model 200 described with reference to FIG. 2. In some examples, the operations shown in FIG. 4 are performed by a system including a processor executing a set of codes to control functional elements of an apparatus, such as the video generation device shown in and described with reference to FIG. 1 or another suitable device described herein.

Additionally, or alternatively, one or more steps of the method 400 shown in FIG. 4 may be performed using special-purpose hardware. Generally, the operations are performed according to the methods and processes described in accordance with aspects of the present disclosure. In some cases, the operations described herein include various substeps, or are performed in conjunction with other operations.

At operation 405, a user provides an input prompt (e.g., a text prompt) describing content to be included in a generated media item. For example, a user may provide the prompt “a person playing with a cat”. In some examples, the input prompt can include guidance provided in a form other than text, such as an image, a sketch, or a layout.

At operation 410, the system converts the input prompt (and/or other guidance) into one or more conditional guidance vectors or another multi-dimensional representation. For example, text may be converted into a vector or a series of vectors using a transformer model, or a multi-modal encoder. In some cases, the encoder for the conditional guidance is trained independently of the diffusion model.

At operation 415, the system initializes a noise map that includes random noise. The noise map may be in a pixel space or a latent space. By initializing a media item with random noise, the system can generate different variations of a media item including the content described by the conditional guidance provided in the input prompt.

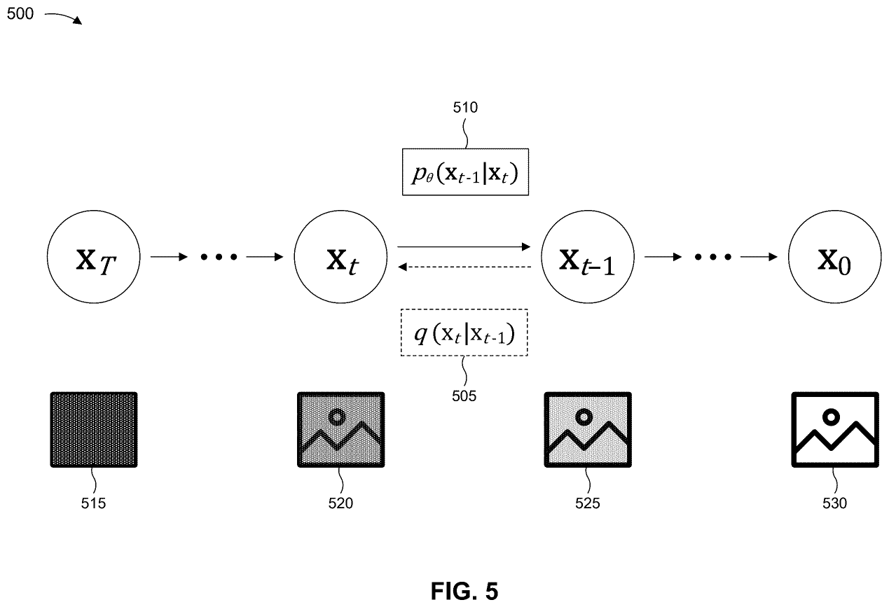

At operation 420, the system generates a media item based on the noise map and the conditional guidance vector(s). For example, the media item may be generated using the reverse diffusion process 225 described with reference to FIG. 4, a reverse diffusion process as described with reference to FIG. 5, or another suitable reverse diffusion process.

As indicated above, FIG. 4 is provided as an example. Other examples may differ from what is described with regard to FIG. 4.

FIG. 5 illustrates an example diffusion process 500, according to some aspects of the present disclosure. In some examples, the diffusion process 500 describes an operation of the diffusion model 1415 described with reference to FIG. 14, such as the reverse diffusion process 225 of the guided diffusion model 200 described with reference to FIG. 2.

As described above with reference to FIG. 2, using a diffusion model can involve both a forward diffusion process 505 for adding noise to a media item (or features in a latent space) and a reverse diffusion process 510 for denoising the media item (or features) to obtain a denoised media item. The forward diffusion process 505 can be represented as q(xₜ|xₜ₋₁), and the reverse diffusion process 510 can be represented as p(xₜ₋₁|xₜ). In some cases, the forward diffusion process 505 is used during training to generate media items with successively greater noise, and a neural network is trained to perform the reverse diffusion process 510 (e.g., to successively remove the noise).

In an example forward diffusion process for a latent diffusion model, the model maps an observed variable x₀ (either in a pixel space or a latent space) to intermediate variables x₁, . . . , x_{T} using a Markov chain. The Markov chain gradually adds Gaussian noise to the data to obtain an approximate posterior q(x_{1:T}|x₀) as the latent variables are passed through a neural network such as a U-Net (e.g., U-Net 300), where x₁, . . . , x_{T} have the same dimensionality as x₀.

The neural network may be trained to perform the reverse diffusion process 510. During the reverse diffusion process 510, the model begins with noisy data x_{T}, such as a noisy media item 515, and denoises the data to obtain p(xₜ₋₁|xₜ). At each step t−1, the reverse diffusion process 510 takes xₜ, such as a first intermediate media item 520, and t as inputs, where t represents a step in a sequence of transitions associated with different noise levels. The reverse diffusion process 510 iteratively outputs xₜ₋₁, such as a second intermediate media item 525 from a first intermediate media item 520, until x_{T} reverts back to x₀, where x₀ is the observed variable such as an original media item 530. In some examples, the reverse diffusion process 510 can be represented as:

p_{θ}(xₜ₋₁|xₜ):=N(xₜ₋₁;μ_{θ}(xₜ,t),Σ_{θ}(xₜ,t)) (2)

The joint probability of a sequence of samples in the Markov chain can be written as a product of conditionals and the marginal probability, as follows:

$${x}_{T} : {p}_{θ} ( {x}_{0 : T} ) := p ( {x}_{T} ) {\prod }_{t = 1}^{T} {p}_{θ} ( {x}_{t - 1} \vert {x}_{t} ) \qquad ( 3 )$$

where p(x_{T})=N(x_{T}; 0, I) is the pure noise distribution as the reverse diffusion process 510 takes the outcome of the forward diffusion process 505 (e.g., a pure noise sample) as an input, and where

$${\prod }_{t = 1}^{T} {p}_{θ} ( {x}_{t - 1} \vert {x}_{t} )$$

represents a sequence of Gaussian transitions corresponding to a sequence adding Gaussian noise to the sample.

In some examples, at interference time, observed data x₀ in a pixel space can be mapped into a latent space as an input, and generated data \tilde{x} is mapped back into the pixel space from the latent space as an output. In some examples, x₀ represents an original input media item with low quality, latent variables x₁, . . . , x_{T} represent noisy media items, and x represents the generated media item with high quality.

As indicated above, FIG. 5 is provided as an example. Other examples may differ from what is described with regard to FIG. 5.

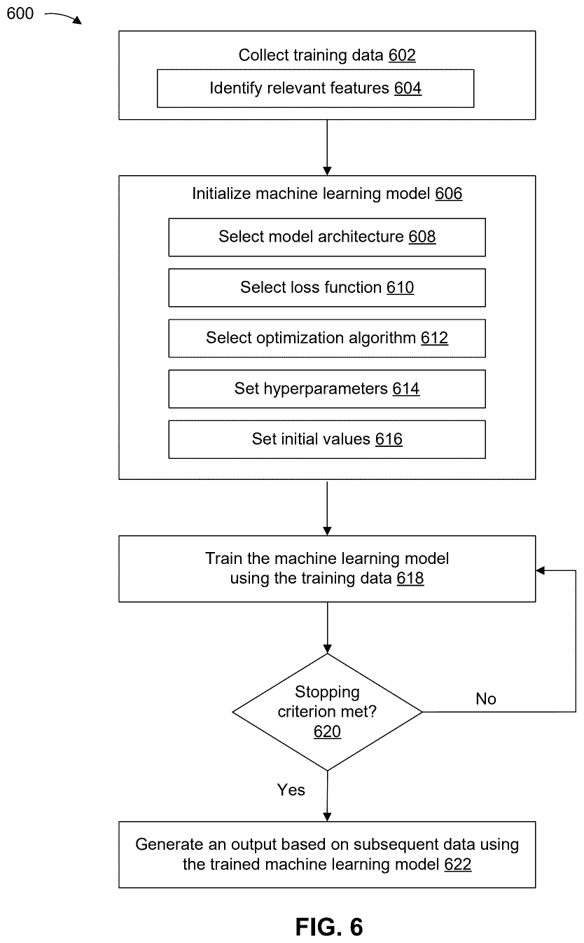

FIG. 6 is a flow diagram illustrating an example procedure 600 for training a machine learning model, according to some aspects of the present disclosure. In some aspects, the procedure 600 describes operation of the training component 1425 for configuring the diffusion model 1415 described with reference to FIG. 14. The procedure 600 provides one or more examples of generating training data, using the training data to train a machine learning model, and using the trained machine learning model to perform a task.

In some examples, a machine learning system collects training data (block 602) that is to be used as a basis to train a machine learning model (e.g., data that defines what is being modeled). The training data is collectable by the machine learning system from various sources. For example, training data sources include public datasets, service provider system platforms that expose application programming interfaces (e.g., social media platforms), and user data collection systems (e.g., digital surveys and online crowdsourcing systems), among other examples. Training data collection may also include data augmentation and synthetic data generation techniques to expand and diversify available training data and/or balancing techniques to balance a number of positive and negative examples, among other examples.

In some aspects, the machine learning system is configurable to identify features that are relevant to a type of task (block 604) for which the machine learning model is to be trained. For example, example machine learning tasks include classification, natural language processing, generative artificial intelligence, recommendation engines, reinforcement learning, and clustering, among other examples. The machine learning system collects the training data based on the identified features and/or filters the training data based on the identified features after collection. The training data is then utilized to train a machine learning model.

In the example procedure 600 illustrated in FIG. 6, in order to train the machine learning model, the machine learning model is first initialized (block 606). Initializing the machine learning model includes selecting a model architecture (block 608) to be trained. Example model architectures include neural networks, convolutional neural networks (CNNs), long short-term memory (LSTM) neural networks, generative adversarial networks (GANs), decision trees, support vector machines, linear regression, logistic regression, Bayesian networks, random forest learning, dimensionality reduction algorithms, boosting algorithms, and deep learning neural networks, among other examples.

As further shown in FIG. 6, initializing the machine learning model includes selecting a loss function (block 610). The loss function is utilized to measure a difference between an output of the machine learning model (e.g., predictions or inferences) and target values (e.g., as expressed by the training data) to be used to train the machine learning model. Additionally, initializing the machine learning model includes selecting an optimization algorithm (block 612) to be used in conjunction with the loss function to optimize parameters of the machine learning model during training. Example optimization algorithms include gradient descent and stochastic gradient descent (SGD), among other examples.

As further shown in FIG. 6, initializing the machine learning model includes setting hyperparameters of the machine learning model (block 614) and setting initial values of the machine learning model (block 616). The hyperparameters are used to control training of the machine learning model, and example hyperparameters include regularization parameters, model parameters (e.g., a number of layers in a neural network), a learning rate, and batch sizes selected from the training data, among other examples. The hyperparameters are set using one or more techniques, such as a randomization technique, or using heuristics learned from other training scenarios, among other examples. Example initial values that are set for the machine learning model include weights and biases of nodes to improve efficiency in training and computational resources consumption as part of training.

As further shown in FIG. 6, the machine learning model is then trained using the training data (block 618) by the machine learning system. A machine learning model is a computer representation that can be tuned (e.g., trained and retrained) based on inputs of the training data to approximate unknown functions. In particular, a machine learning model can include a model that utilizes algorithms (e.g., using the model architectures described above) to learn from, and make predictions on, known data by analyzing training data to learn and relearn to generate outputs that reflect patterns and attributes expressed by the training data.

Example training techniques include supervised learning that employs labeled data, unsupervised learning that involves finding underlying structures or patterns within the training data, reinforcement learning based on optimization functions (e.g., rewards and/or penalties), and use of nodes as part of “deep learning,” among other examples. For example, the machine learning model may be configurable to include a plurality of nodes that collectively form a plurality of layers. The layers, for instance, are configurable to include an input layer, an output layer, and one or more hidden layers. Calculations are performed by the nodes within the layers through hidden states through a system of weighted connections that are “learned” during training (e.g., through use of a selected loss function and backpropagation to optimize performance of the machine learning model to perform an associated task).

As further shown in FIG. 6, training the machine learning model includes determining whether a stopping criterion is met (decision block 620), where the stopping criterion is used to validate the machine learning model. The stopping criterion is usable to reduce overfitting of the machine learning model, to reduce computational resource consumption, and to promote an ability of the machine learning model to address previously unseen data (e.g., data that is not included specifically as an example in the training data). Example stopping criteria include a threshold number of epochs, validation loss stabilization, satisfaction of a performance improvement threshold, achieving a threshold level of accuracy, or satisfaction of performance metrics such as precision and recall, among other examples. As shown in FIG. 6, in cases where the stopping criterion has not been met (“no” from decision block 620), the procedure 600 continues training the machine learning model using the training data (block 618). As shown in FIG. 6, in cases where the stopping criterion has been met (“yes” from decision block 620), the trained machine learning model is then utilized to generate an output based on subsequent data (block 622). For example, the machine learning model is trained to perform a task as described above and, after training, is configured to perform the task based on subsequent data that is received as an input and processed by the machine learning model.

As indicated above, FIG. 6 is provided as an example. Other examples may differ from what is described with regard to FIG. 6.

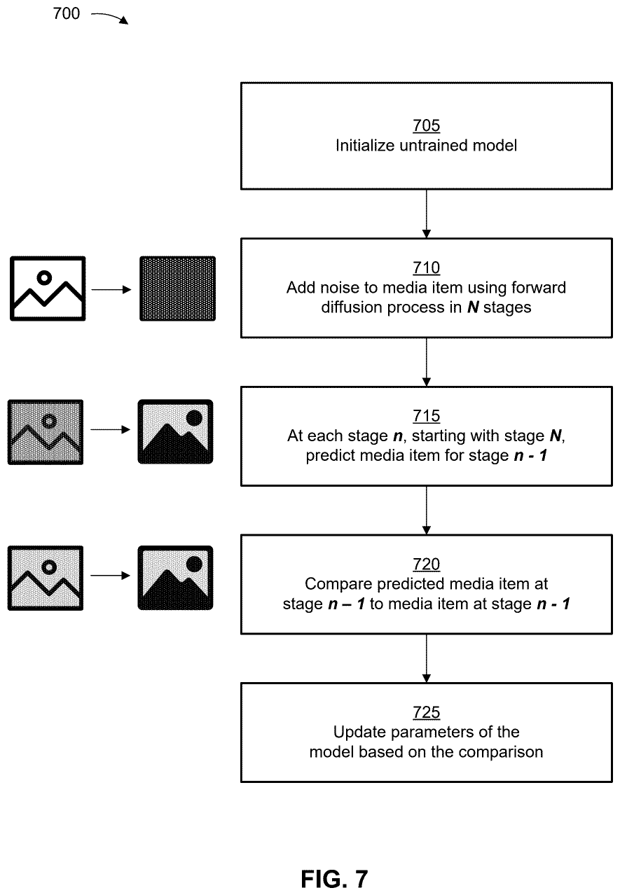

FIG. 7 illustrates an example method 700 for training a diffusion model, according to some aspects of the present disclosure. In some aspects, the method 700 describes operation of the training component 1425 for configuring the diffusion model 1415 described with reference to FIG. 14. The method 700 provides one or more examples of training a reverse diffusion process, as described above with reference to FIG. 2 and/or FIG. 5. In some examples, the operations shown in FIG. 7 are performed by a system including a processor executing a set of codes to control functional elements of an apparatus, such as the video generation device shown in and described with reference to FIG. 1 or another suitable device described herein.

Additionally, or alternatively, one or more steps of the method 700 shown in FIG. 7 may be performed using special-purpose hardware. Generally, the operations are performed according to the methods and processes described in accordance with aspects of the present disclosure. In some cases, the operations described herein include various substeps, or are performed in conjunction with other operations.

At operation 705, a user initializes an untrained model. Initializing the untrained model can include defining the architecture of the model and establishing initial values for the parameters associated with the model. In some examples, the initialization can include defining hyperparameters such as the number of layers, the resolution and channels of each layer block, and/or the location of skip connections, among other examples.

At operation 710, the system adds noise to a media item using a forward diffusion process in N stages. In some examples, the forward diffusion process is a fixed process where Gaussian noise is successively added to the media item. In latent diffusion models, the Gaussian noise may be successively added to features in a latent space.

At operation 715, the system performs a reverse diffusion process at each stage n, starting with stage N, to predict the output or features at stage n−1. For example, the reverse diffusion process can predict the noise that was added by the forward diffusion process, and the predicted noise can be removed from the noise input to obtain the predicted output. In some examples, an original media item is predicted at each stage of the training process.

At operation 720, the system compares a predicted output (or features) at stage n−1 to an actual media item (or features), such as the output at stage n−1 or the original input. For example, given observed data x, the diffusion model may be trained to minimize a variational upper bound of a negative log-likelihood −log p_{θ}(x) of the training data.

At operation 725, the system updates parameters of the model based on the comparison of the predicted output at stage n−1 and the output at stage n. For example, the parameters of a U-Net may be updated using gradient descent or other suitable techniques. Time-dependent parameters of the Gaussian transitions can also be learned.

As indicated above, FIG. 7 is provided as an example. Other examples may differ from what is described with regard to FIG. 7.

FIG. 8 illustrates an example 800 associated with tuning-free video generation using synchronized coupled sampling, according to some aspects of the present disclosure. As described herein, example 800 may be implemented using a diffusion model that supports a synchronized coupled sampling framework to iteratively denoise an input video to generate an output video with smooth and seamless transitions between adjacent frames or segments, dynamic changes during the video, and long-term temporal consistency across the entire video. In some aspects, example 800 includes interaction between a user and a video generation device that uses the diffusion model to generate the video based on input from the user. For example, the video generation device may be a user device that interfaces with directly with the user, a server that provides a user interface for interfacing with the user via a user device, or a server that performs processing tasks to provide computational resources to support the user device.

As shown by reference number 805, the user may provide an input prompt to describe a video to be generated. For example, in some aspects, a user may provide the input prompt via one or more text prompts to describe a comprehensive story or scenario, and the input prompt may be processed using an LLM or another suitable model to structure the input prompt according to a global prompt that describes shared properties across the entire video and one or more local prompts that specify dynamic changes, such as object appearances, styles, motions, camera viewpoint changes, actions, or descriptive adjectives, among other examples. Accordingly, as described in further detail above with reference to FIG. 1, the global prompt provides guidance to the diffusion model to ensure a consistent description of shared properties across the entire video, and respective local prompts provide guidance that build on the global prompt to incorporate dynamic controls for shorter segments within the video.

As shown by reference number 810, the diffusion model initializes a noisy data item,

$${x}_{T}^{′} ,$$

such as a noise map that includes Gaussian noise or random noise. As shown by reference number 815, the noisy data item is input to a denoising component that gradually removes noise to generate a video associated with the input prompt. For example, as described in further detail herein, the denoising component performs a denoising operation from t=T until t=0, where each iteration in the denoising operation receives an input video

$${x}_{t}^{′}$$

and generates an output video

$${x}_{t - 1}^{′} ,$$

where t represents a step in a sequence of transitions associated with different noise levels. Accordingly, the denoising operation is iteratively performed until the noisy data item

$${x}_{T}^{′}$$

reverts to a final output video

$${x}_{0}^{′} ,$$

as shown by reference number 820. In some aspects, the denoising component includes or implements one or more aspects of the reverse diffusion process 225 shown in and described with reference to FIG. 2, the U-Net 300 shown in and described with reference to FIG. 3, the method 400 shown in and described with reference to FIG. 4, or the reverse diffusion process 510 shown in and described with reference to FIG. 5. In addition, the denoising component implements a synchronized coupled sampling framework to ensure seamless transitions between adjacent segments in the final output video and long-term semantic consistency throughout the entire output video. For example, reference number 825 illustrates operations or steps in the denoising operation that is iteratively performed by the denoising component from t=T until t=0, starting from a noisy data item,

$${x}_{T}^{′} ∼ N ( 0 , I ) , where {x}_{T}^{′} ∼ N ( 0 , I )$$

denotes a data item with noise sampled from a standard normal distribution.

As shown by reference number 830, each iteration in the denoising operation includes segmenting an input video

$${x}_{t}^{′}$$

associated with a current iteration into overlapping segments according to a configured stride value, where each segment is denoted

$${x}_{t}^{i}$$

and each segment is associated with a respective text prompt embedding denoted cᵢ. The text prompt embedding cᵢ for any given segment

$${x}_{t}^{i}$$

is based on the global prompt shared by all segments

$${x}_{t}^{i}$$

and a local prompt associated with the segment

$${x}_{t}^{i} .$$

As shown by reference number 835, a forward diffusion operation associated with a DDIM update is then performed on each segment

$${x}_{t}^{i} ,$$

with the associated text prompt embedding cᵢ guiding denoising for the segment

$${x}_{t}^{i} .$$

For example, the denoising for each segment

$${x}_{t}^{i}$$

uses CFG with the associated text prompt embedding cᵢ, where CFG combines conditional and unconditional outputs with a guidance scale to modify denoising model predictions. As shown by reference number 840, after performing the forward diffusion operation, an intermediate output

$${x}_{0}^{i}$$

is obtained for each segment

$${x}_{t}^{i} ,$$

and the intermediate outputs are fused to obtain an intermediate output video

$${x}_{0}^{′} .$$

For example, in some aspects, the intermediate outputs are fused using weighted averaging based on the number of segments

$${x}_{t}^{i} .$$

Furthermore, by performing the DDIM on each segment until obtaining the intermediate output

$${x}_{0}^{i}$$

for each segment

$${x}_{t}^{i} ,$$

and then fusing the intermediate outputs, the fused intermediate output video is obtained at a data space,

$${x}_{0}^{′} .$$

In some aspects, as shown by reference number 845, the fused intermediate output video

$${x}_{0}^{′}$$

is refined according to inter-sample affinities (e.g., based on one or more parameters that measure a similarity or dissimilarity between samples) using CSD sampling in iterations of the denoising operation from t=T until t=tₘᵢₙ, where tₘᵢₙ is a configurable parameter based on the number of iterations of the denoising operation that result in a semantically consistent layout. In other words, the CSD sampling is performed only in an early denoising stage, until t=tₘᵢₙ, because the diffusion model generates coarse-grained structures at larger (earlier) timesteps and adds finer details later at smaller (later) timesteps. Accordingly, after T−tₘᵢₙ iterations, a coherent semantic layout has been established for the (denoised) video, and later iterations from t=tₘᵢₙ until t=0 only perform the DDIM update to focus on adding image-level details without compromising the coherence and fine grained quality of the long-duration video.

In some aspects, in the iterations where the intermediate output video

$${x}_{0}^{′}$$

is refined using CSD sampling, the intermediate output video

$${x}_{0}^{′}$$

is divided into overlapping segments to perform a forward diffusion process on each segment. Alternatively, rather than optimizing all segments, a subset of the overlapping segments may be sampled in each iteration where the CSD optimization is performed (e.g., to reduce memory usage, processor usage, or other computational costs). In the refinement step, CSD sampling is used to calculate a score, L_{CSD}, for each segment (or each sampled segment). For example, the CSD sampling is based on score distillation sampling (SDS) techniques, where a Jacobian term of a U-Net can be omitted from an expression of the gradient of a diffusion model loss function with respect to a parameter θ given x=g(θ), where x is a sample and g is any arbitrary differentiable parametric function. In SDS, omitting the Jacobian term of the U-Net yields an effective gradient for estimating an update direction that follows the score function of a diffusion model, thereby moving toward a higher-density region. In CSD sampling, SDS is extended from a single sample, x, to enable inter-sample consistency by synchronizing gradient updates across multiple samples,

$${\{ {x}^{i} \}}_{i = 1}^{N} ,$$

allowing the samples to influence each other and increase inter-sample similarity during optimization. In particular, CSD sampling generalizes SDS by using Stein variational gradient descent (SVGD) to align gradient directions across multiple samples, which ensures that each parameter update is influenced by other samples, with scores adjusted via importance weights based on sample affinity or similarity. In this way, CSD sampling promotes inter-sample consistency. In some aspects, after L_{CSD} has been calculated for each segment or sampled segment of the intermediate output video, the gradients are then fused to refine the intermediate output

$${x}_{0}^{i}$$

for each segment (e.g., using weighted averaging based on the number of overlapping segments). Accordingly, by combining scores from multiple segments, the CSD sampling can handle scenarios where multiple prompts introduce diverging denoising paths. For example, despite any diverging denoising paths, the CSD optimization aligns denoising levels across video segments and synchronously updates the scores, which minimizes content or style drift and preserves global semantic consistency.

As further shown by reference number 850, in each iteration from t=T until t=0, the intermediate output video

$${x}_{0}^{′}$$

is reverted to a previous timestep,

$${x}_{t - 1}^{′} .$$

For example, in iterations from t=T until t=tₘᵢₙ, the fused intermediate output video

$${x}_{0}^{′}$$

generated by the DDIM update is refined using CSD sampling and then reverted to the previous timestep. In iterations from t=tₘᵢₙ until t=0, CSD optimization is not performed and the fused intermediate output video

$${x}_{0}^{′}$$

generated by the DDIM update is then reverted to the previous timestep. In some aspects, in iterations where the CSD sampling is performed, reverting

$${x}_{0}^{′}$$

to the previous timestep includes re-deriving

$${x}_{0}^{′}$$

based on the refined

$${x}_{t}^{′}$$

by first adding noise to

$${x}_{0}^{′}$$

and then computing the posterior distribution of

$${x}_{t - 1}^{′}$$

using the refined

$${x}_{0}^{′}$$

and the re-derived sample

$${x}_{t}^{′} .$$

After t reaches 0, the resulting output video is generated for output to the user.

As indicated above, FIG. 8 is provided as an example. Other examples may differ from what is described with regard to FIG. 8.

FIG. 9 illustrates an example 900 associated with tuning-free video generation using synchronized coupled sampling, according to some aspects of the present disclosure. As described herein, example 900 may be implemented using a diffusion model that supports a synchronized coupled sampling framework to iteratively denoise an input video to generate an output video with smooth and seamless transitions between adjacent frames or segments, dynamic changes during the video, and long-term temporal consistency across the entire video. In some aspects, the diffusion model implementing example 900 performs inferencing operations that may be executed are on a user device that interfaces with directly with a user, a server that provides a user interface for interfacing with a user via a user device, or a server that performs processing tasks to provide computational resources to support a user device.

As described herein, example 900 illustrates steps in an iterative denoising operation, which takes a noisy data item,

$${x}_{T}^{′} ,$$

as an initial input and generates a video,

$${x}_{0}^{′} ,$$

as a final output after performing iterations from t=T until t=0. For example, each iteration takes an input video

$${x}_{t}^{′}$$

as an input and generates an output video

$${x}_{t - 1}^{′} ,$$

which serves as the input video for a next iteration for each iteration except the iteration where t=1. As described herein, t represents a timestep in a sequence of transitions associated with different noise levels. For example, the sequence of transitions may be defined according to a DDIM schedule, where the timestep is larger in earlier iterations to generate coarse-grained structures and smaller in later iterations to add finer (e.g., image-level) details to the coarse-grained structures generated in earlier iterations. Accordingly, the denoising operation is iteratively performed until the noisy data item

$${x}_{T}^{′}$$

reverts to the final output video

$${x}_{0}^{′} .$$

As shown in FIG. 9, a first iteration of the denoising operation receives an input video corresponding to a noisy data item,

$${x}_{T}^{′} ∼ N ( 0 , I ) , where {x}_{T}^{′} ∼ N ( 0 , I )$$

denotes a data item with noise sampled from a standard normal distribution. As shown in FIG. 9, the noisy data item,

$${x}_{T}^{′} ,$$

is associated with a global prompt (g) that describes shared properties associated with the entire video, and one or more local prompts (l₁, l₂, l₃, l₄) that each build on the global prompt and provide additional details applicable to only a portion or segment within the overall video.

As shown by reference number 910, each iteration in the denoising operation includes a DDIM update stage, where the input video

$${x}_{t}^{′}$$

for a current iteration is divided into overlapping segments according to a configured stride value, where each segment is denoted

$${x}_{t}^{i}$$

and each segment is associated with a respective text prompt embedding denoted cᵢ. The text prompt embedding cᵢ for any given segment

$${x}_{t}^{i}$$

is based on the global prompt shared by all segments

$${x}_{t}^{i}$$

and the respective local prompt associated with the segment

$${x}_{t}^{i} .$$

As shown in FIG. 9, a forward diffusion operation is then performed on each segment

$${x}_{t}^{i} ,$$

where the respective segments

$${x}_{t}^{i}$$

are input to a diffusion model (e.g., a T2V diffusion model) that adds noise to the respective segments

$${x}_{t}^{i} .$$

The DDIM update is then performed on each segment

$${x}_{t}^{i}$$

individually to remove the added noise, with the associated text prompt embedding cᵢ guiding the denoising for each respective segment

$${x}_{t}^{i} .$$

For example, the denoising for each segment

$${x}_{t}^{i}$$

uses CFG with the associated text prompt embedding cᵢ. After performing the forward diffusion operation, the DDIM is performed for each segment

$${x}_{t}^{i}$$

until an intermediate output

$${x}_{0}^{i}$$

is obtained for each segment

$${x}_{t}^{i} ,$$

and the intermediate outputs are fused to obtain an intermediate output video

$${x}_{0}^{′} .$$

For example, the intermediate outputs for the various segment

$${x}_{t}^{i}$$

are fused using weighted averaging based on the number of segments

$${x}_{t}^{i} .$$

By performing the DDIM update on each segment

$${x}_{t}^{i}$$

until obtaining the intermediate output

$${x}_{0}^{i}$$

for each segment

$${x}_{t}^{i} ,$$

and then fusing the intermediate outputs, the fused intermediate output video is obtained at a data space,

$${x}_{0}^{′} .$$

In some aspects, as shown by reference number 920, the fused intermediate output video

$${x}_{0}^{′}$$

is refined based on inter-sample affinities using CSD sampling in early iterations of the denoising operation, from t=T until t=tₘᵢₙ, where tₘᵢₙ is a configurable parameter based on the number of iterations of the denoising operation that result in a semantically consistent layout. The CSD sampling is performed only in an early denoising stage, until t=tₘᵢₙ, because the diffusion model generates coarse-grained structures at larger (earlier) timesteps and adds finer details later at smaller (later) timesteps. Accordingly, after T−tₘᵢₙ iterations, a coherent semantic layout has been established for the (denoised) video, and later iterations from t=tₘᵢₙ until t=0 only perform the DDIM update to focus on adding image-level details without compromising the coherence and fine grained quality of the long-duration video.

In some aspects, in the iterations where the intermediate output video

$${x}_{0}^{′}$$

is refined using CSD sampling, the intermediate output video

$${x}_{0}^{′}$$

is divided into overlapping segments to perform a forward diffusion process on each segment. Alternatively, rather than optimizing all segments, a subset of the overlapping segments may be sampled in each iteration where the CSD optimization is performed (e.g., to reduce memory usage, processor usage, or other computational costs). In the refinement step, CSD sampling is used to calculate a score, L_{CSD}, for each segment (or each sampled segment). For example, the CSD sampling is based on score distillation sampling (SDS) techniques, where a Jacobian term of a U-Net can be omitted from an expression of the gradient of a diffusion model loss function with respect to a parameter θ given x=g(θ), where x is a sample and g is any arbitrary differentiable parametric function. In CSD sampling, inter-sample consistency is increased by synchronizing gradient updates across multiple samples,

$${\{ {x}^{i} \}}_{i = 1}^{N}$$

based on SVGD techniques to align gradient directions across multiple samples. For example, Gaussian noise is sampled for each sample, ϵⁱ~N(0, I), and each sample, xⁱ=g(θᵢ), is optimized according to an objective based on one or more parameters that measure similarity between samples. In this way, the CSD sampling leverages inter-sample relationships and ensures that each parameter update is influenced by other samples, with scores adjusted via importance weights based on sample affinity. For example, CSD adjusts gradient updates according to sample affinity (e.g., a measure of similarity or dissimilarity) to increase global coherency (more similarity) among samples.

In addition, to reduce variance in the CSD optimization stage, which is often caused by random noise sampling and/or random timestep selection at each optimization iteration, the synchronized coupled sampling framework described herein uses a noise-grounding configuration. For example, the noise-grounding configuration fixes a baseline noise, ϵ_{base} when the CSD sampling is initialized, and then optimizing through the CSD sampling by taking each

$${x}_{0}^{′}$$

and a corresponding portion of the baseline noise, ϵ_{base}. In addition, rather than using random timesteps, the CSD sampling follows a fixed timestep according to the DDIM schedule. In this way, the noise-grounding configuration improves prompt fidelity and reduces content drift by providing consistent gradient update directions across segments.

After L_{CSD} has been calculated for each segment or each sampled segment of the intermediate output video, the gradients are then fused to refine the intermediate output

$${x}_{0}^{′}$$

for each segment. Accordingly, by combining scores from multiple segments, the CSD sampling can handle scenarios where multiple prompts introduce diverging denoising paths by aligning denoising levels across segments and synchronously updating the scores, which minimizes content or style drift and preserves global semantic consistency.

As shown by reference number 930, in each iteration from t=T until t=0, the intermediate output video

$${x}_{0}^{′}$$

is reverted to a previous timestep,

$${x}_{t - 1}^{′} .$$

For example, in iterations from t=T until t=tₘᵢₙ, the fused intermediate output video

$${x}_{0}^{′}$$

that is refined using CSD sampling is reverted to the previous timestep. In iterations from t=tₘᵢₙ until t=0, where CSD optimization is not performed, the fused intermediate output video

$${x}_{0}^{′}$$

generated by the DDIM update is reverted to the previous timestep. In iterations where the CSD sampling is performed, reverting

$${x}_{0}^{′}$$

to the previous timestep includes adding noise to

$${x}_{0}^{′}$$

and then computing the posterior distribution of

$${x}_{t - 1}^{′}$$

using the refined

$${x}_{0}^{′}$$

and the re-derived sample

$${x}_{t}^{′} .$$

As shown by reference number 940, after t reaches 0, the resulting output video is then generated for output to the user, where the output video includes one or more segments that are each associated with the global prompt and a respective local prompt. For example, in FIG. 9, the output video includes a first segment associated with prompts (g, l₁), a second segment associated with prompts (g, l₂), a third segment associated with prompts (g, l₃), and a fourth segment associated with prompts (g, l₄).

As indicated above, FIG. 9 is provided as an example. Other examples may differ from what is described with regard to FIG. 9.

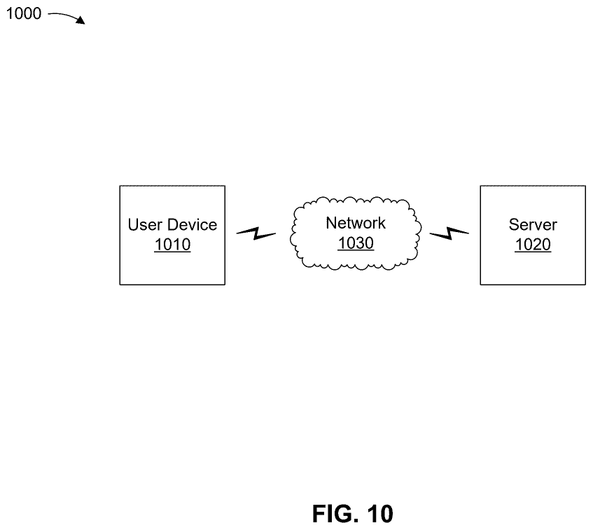

FIG. 10 is a diagram illustrating an example environment 1000 associated with tuning-free video generation using synchronized coupled sampling, according to some aspects of the present disclosure. As shown in FIG. 10, the environment 1000 may include a user device 1010, a server 1020, and a network 1030. Devices in the environment 1000 may interconnect via wired connections, wireless connections, or a combination thereof.

The user device 1010 includes one or more devices capable of receiving, generating, storing, processing, and/or providing information associated with tuning-free video generation using synchronized coupled sampling, as described elsewhere herein. In some aspects, the user device 1010 may be configured to use a diffusion model associated with a synchronized coupled sampling framework to generate a video from an input prompt, as described above with reference to FIG. 1, FIG. 8, and/or FIG. 9. Additionally, or alternatively, the user device 1010 may be configured to interact with the server 1020 to provide inputs and receive outputs associated with the diffusion model. For example, the user device 1010 may execute an application that can generate the video using the diffusion model, may communicate with the server 1020 to utilize resources of the server 1020 to generate the video, or may communicate with the server 1020 to generate the video using a diffusion model hosted on the server 1020. The user device 1010 may include a processing device, a communication device, and/or a computing device. For example, the user device 1010 may include a wireless communication device, a mobile phone, a user equipment, a laptop computer, a tablet computer, a desktop computer, a gaming console, a set-top box, a wearable communication device (e.g., a smart wristwatch, a pair of smart eyeglasses, a head mounted display, or a virtual reality headset), or a similar type of device.

The server 1020 includes one or more devices capable of receiving, generating, storing, processing, providing, and/or routing information associated with tuning-free video generation using synchronized coupled sampling, as described elsewhere herein. In some aspects, the server 1020 may be configured to use a diffusion model associated with a coupled sampling framework to generate a video from an input prompt, as described above with reference to FIG. 1, FIG. 8, and/or FIG. 9. The server 1020 may include a processing device, a communication device, and/or a computing device. For example, the server 1020 may include an application server, a client server, a web server, a database server, a host server, a proxy server, a virtual server (e.g., executing on computing hardware), or a server in a cloud computing system. In some aspects, the server 1020 may include computing hardware used in a cloud computing environment, such as one or more serverless components (e.g., one or more serverless functions).

The network 1030 may include one or more wired and/or wireless networks. For example, the network 1030 may include a wireless wide area network (e.g., a cellular network or a public land mobile network), a local area network (e.g., a wired local area network or a wireless local area network (WLAN), such as a Wi-Fi network), a personal area network (e.g., a Bluetooth network), a near-field communication network, a telephone network, a private network, the Internet, and/or a combination of these or other types of networks. The network 1030 enables communication among the devices of environment 1000.

The number and arrangement of devices and networks shown in FIG. 10 are provided as an example. In practice, there may be additional devices and/or networks, fewer devices and/or networks, different devices and/or networks, or differently arranged devices and/or networks than those shown in FIG. 10. Furthermore, two or more devices shown in FIG. 10 may be implemented within a single device, or a single device shown in FIG. 10 may be implemented as multiple, distributed devices. Additionally, or alternatively, a set of devices (e.g., one or more devices) of environment 1000 may perform one or more functions described as being performed by another set of devices of environment 1000.

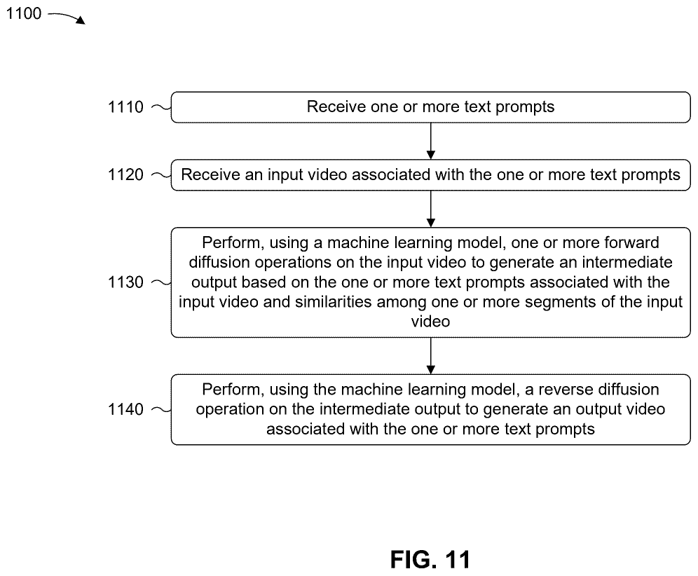

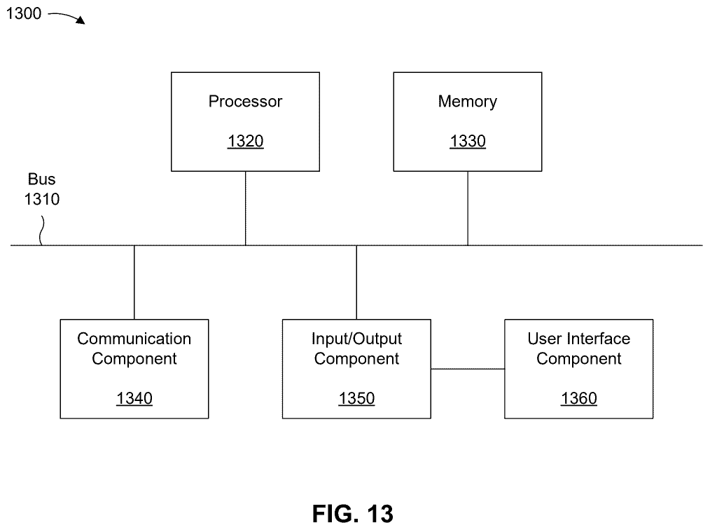

FIG. 11 is a flowchart of an example process 1100 associated with tuning-free video generation using synchronized coupled sampling. One or more process blocks of FIG. 11 are performed by a processing device (e.g., user device 1010 or server 1020) and/or by another device or a group of devices separate from or including the processing device. Additionally, or alternatively, one or more process blocks of FIG. 11 may be performed by one or more components of the device 1300 depicted in FIG. 13, such as processor 1320, memory 1330, communication component 1340, I/O component 1350, and/or user interface component 1360.

As shown in FIG. 11, process 1100 includes receiving one or more text prompts (block 1110). For example, the processing device may receive one or more text prompts, as described above.

As shown in FIG. 11, process 1100 includes receiving an input video associated with the one or more text prompts (block 1120). For example, the processing device may receive an input video associated with the one or more text prompts, as described above.

As further shown in FIG. 11, process 1100 includes performing, using a machine learning model, one or more forward diffusion operations on the input video to generate an intermediate output based on the one or more text prompts associated with the input video and similarities among one or more segments of the input video (block 1130). For example, the processing device may perform, using a machine learning model, one or more forward diffusion operations on the input video to generate an intermediate output based on the one or more text prompts associated with the input video and similarities among one or more segments of the input video, as described above.

As further shown in FIG. 11, process 1100 includes performing, using the machine learning model, a reverse diffusion operation on the intermediate output to generate an output video associated with the one or more text prompts (block 1140). For example, the processing device may perform, using the machine learning model, a reverse diffusion operation on the intermediate output to generate an output video associated with the one or more text prompts, as described above.

Process 1100 may include additional aspects, such as any single aspect or any combination of aspects described below and/or in connection with one or more other processes described elsewhere herein.

In a first aspect, the one or more forward diffusion operations include a first forward diffusion operation and a second forward diffusion operation, and wherein the first forward diffusion operation and the reverse diffusion operation are associated with a denoise diffusion implicit model (DDIM) update operation for the input video.

In a second aspect, alone or in combination with the first aspect, the second forward diffusion operation is performed during the DDIM update operation.

In a third aspect, alone or in combination with one or more of the first and second aspects, the first forward diffusion operation and the second forward diffusion operation are associated with a fixed timestep based on a schedule associated with the DDIM update operation.

In a fourth aspect, alone or in combination with one or more of the first through third aspects, performing the one or more forward diffusion operations includes generating, using the machine learning model, the intermediate output based on the one or more text prompts, dividing the intermediate output into overlapping segments, sampling the one or more segments from the overlapping segments of the intermediate output, determining, using the machine learning model and for each segment of the one or more segments, a respective score based on an inter-sample similarity among adjacent segments and distant segments among the one or more segments sampled from the intermediate output, and performing, using the machine learning model, a fusion operation on the overlapping segments of the intermediate output to refine the intermediate output according to the respective score for each segment of the one or more segments sampled from the intermediate output.

In a fifth aspect, alone or in combination with one or more of the first through fourth aspects, performing the one or more forward diffusion operations further includes configuring a baseline noise associated with the one or more forward diffusion operations, wherein each segment in the one or more segments sampled from the intermediate output is associated with a respective portion of the baseline noise.

In a sixth aspect, alone or in combination with one or more of the first through fifth aspects, the one or more forward diffusion operations include a first forward diffusion operation performed in a first quantity of iterations and a second forward diffusion operation performed in a second quantity of iterations that is less than the first quantity of iterations.

In a seventh aspect, alone or in combination with one or more of the first through sixth aspects, the one or more text prompts include a global text prompt applicable to each segment of the input video and one or more local text prompts that are each applicable to a respective segment of the input video.

Although FIG. 11 shows example blocks of process 1100, in some implementations, process 1100 includes additional blocks, fewer blocks, different blocks, or differently arranged blocks than those depicted in FIG. 11. Additionally, or alternatively, two or more of the blocks of process 1100 may be performed in parallel.

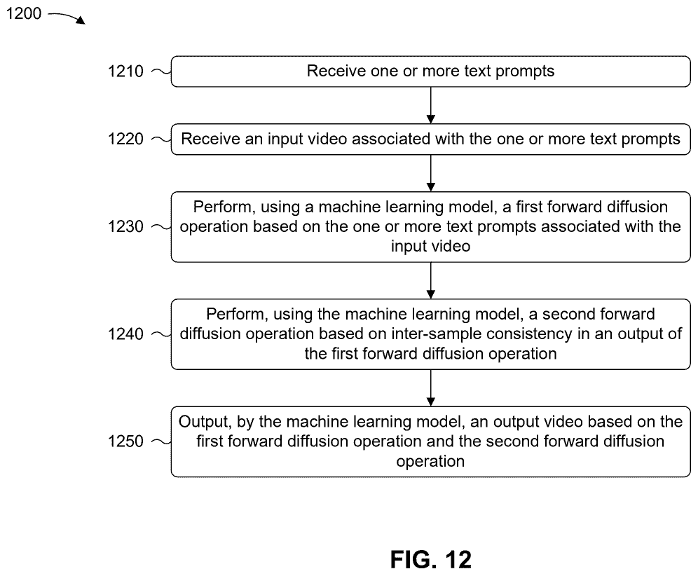

FIG. 12 is a flowchart of an example process 1200 associated with tuning-free video generation using synchronized coupled sampling. One or more process blocks of FIG. 12 are performed by a processing device (e.g., user device 1010 or server 1020) and/or by another device or a group of devices separate from or including the processing device. Additionally, or alternatively, one or more process blocks of FIG. 12 may be performed by one or more components of the device 1300 depicted in FIG. 13, such as processor 1320, memory 1330, communication component 1340, I/O component 1350, and/or user interface component 1360.

As shown in FIG. 12, process 1200 includes receiving one or more text prompts (block 1210). For example, the processing device may receive one or more text prompts, as described above.

As shown in FIG. 12, process 1200 includes receiving an input video associated with the one or more text prompts (block 1220). For example, the processing device may receive an input video associated with the one or more text prompts, as described above.

As further shown in FIG. 12, process 1200 includes performing, using a machine learning model, a first forward diffusion operation based on the one or more text prompts associated with the input video (block 1230). For example, the processing device may perform, using a machine learning model, a first forward diffusion operation based on the one or more text prompts associated with the input video, as described above.

As further shown in FIG. 12, process 1200 includes performing, using the machine learning model, a second forward diffusion operation based on inter-sample consistency in an output of the first forward diffusion operation (block 1240). For example, the processing device may perform, using the machine learning model, a second forward diffusion operation based on inter-sample consistency in an output of the first forward diffusion operation, as described above.

As further shown in FIG. 12, process 1200 includes outputting an output video based on the first forward diffusion operation and the second forward diffusion operation (block 1240). For example, the processing device may output an output video based on the first forward diffusion operation and the second forward diffusion operation, as described above.

Process 1200 may include additional aspects, such as any single aspect or any combination of aspects described below and/or in connection with one or more other processes described elsewhere herein.

In a first aspect, the first forward diffusion operation is associated with a denoise diffusion implicit model (DDIM) update operation for the input video.

In a second aspect, alone or in combination with the first aspect, the second forward diffusion operation is performed during the DDIM update operation.

In a third aspect, alone or in combination with one or more of the first and second aspects, the first forward diffusion operation and the second forward diffusion operation are associated with a fixed timestep based on a schedule associated with the DDIM update operation.

In a fourth aspect, alone or in combination with one or more of the first through third aspects, performing the second forward diffusion operation includes dividing the output of the first forward diffusion operation into overlapping segments, sampling a subset of the overlapping segments, determining, using the machine learning model and for each segment of the subset of the overlapping segments, a respective score based on an inter-sample similarity among adjacent segments and distant segments in the subset of the overlapping segments, and performing, using the machine learning model, a fusion operation on the overlapping segments of the output of the first forward diffusion operation to refine the output of the first forward diffusion operation according to the respective score for each segment of the subset of the overlapping segments.

In a fifth aspect, alone or in combination with one or more of the first through fourth aspects, the first forward diffusion operation is performed in a first quantity of iterations and the second forward diffusion operation is performed in a second quantity of iterations that is less than the first quantity of iterations.

In a sixth aspect, alone or in combination with one or more of the first through fifth aspects, the one or more text prompts include a global text prompt applicable to each segment of the input video and one or more local text prompts that are each applicable to a respective segment of the input video.

Although FIG. 12 shows example blocks of process 1200, in some implementations, process 1200 includes additional blocks, fewer blocks, different blocks, or differently arranged blocks than those depicted in FIG. 12. Additionally, or alternatively, two or more of the blocks of process 1200 may be performed in parallel.

FIG. 13 is a diagram of an example device 1300 associated with tuning-free video generation using synchronized coupled sampling. In some aspects, the device 1300 corresponds to one or more of the user device 1010 and/or the server 1020 shown in FIG. 11. In some aspects, the user device 1010 and/or the server 1020 include one or more devices 1300 and/or one or more components of the device 1300. In the example shown in FIG. 13, the device 1300 includes a bus 1310, a processor 1320, a memory 1330, a communication component 1340, an input/output (I/O) component 1350, and/or a user interface component 1360.

The bus 1310 includes one or more components that enable wired and/or wireless communication among the components of the device 1300. The bus 1310 couples together two or more components of FIG. 13, such as via operative coupling, communicative coupling, electronic coupling, and/or electric coupling. For example, the bus 1310 may include an electrical connection (e.g., a wire, a trace, and/or a lead) and/or a wireless bus. The processor 1320 includes a central processing unit, a graphics processing unit, a microprocessor, a controller, a microcontroller, a digital signal processor, a field-programmable gate array, an application-specific integrated circuit, and/or another type of processing component. The processor 1320 may be implemented in hardware, firmware, or a combination of hardware and software. In some aspects, the processor 1320 includes one or more processors capable of being programmed to perform one or more operations or processes described elsewhere herein.

The memory 1330 includes volatile and/or nonvolatile memory, such as random access memory (RAM), read only memory (ROM), a hard disk drive, and/or another type of memory (e.g., a flash memory, a magnetic memory, and/or an optical memory). The memory 1330 may include internal memory (e.g., RAM, ROM, or a hard disk drive) and/or removable memory (e.g., removable via a universal serial bus connection). In some aspects, the memory 1330 is a non-transitory computer-readable medium. The memory 1330 stores information, one or more instructions, and/or software (e.g., one or more software applications) related to the operation of the device 1300. In some aspects, the memory 1330 includes one or more memories that are coupled (e.g., communicatively coupled) to one or more processors (e.g., processor 1320), such as via the bus 1310. Communicative coupling between a processor 1320 and a memory 1330 enables the processor 1320 to read and/or process information stored in the memory 1330 and/or to store information in the memory 1330.

The communication component 1340 enables the device 1300 to communicate with other devices via a wired connection and/or a wireless connection. For example, the communication component 1340 may include a receiver, a transmitter, a transceiver, a modem, a network interface card, and/or an antenna.

The I/O component 1350 enables the device 1300 to receive input, such as user input and/or sensed input. For example, the I/O component 1350 may include a touch screen, a keyboard, a keypad, a mouse, a button, a microphone, a switch, a sensor, a global positioning system sensor, a global navigation satellite system sensor, an accelerometer, a gyroscope, and/or an actuator. Additionally, or alternatively, the I/O component 1350 enables the device 1300 to provide output, such as via a display, a speaker, and/or a light-emitting diode. In some aspects, the I/O component 1350 is controlled by an I/O controller to manage input and output signals for the device 1300. In some cases, the I/O component 1350 manages peripherals not integrated into the device 1300. In some cases, the I/O component 1350 represents a physical connection or port to an external peripheral. In some cases, the I/O controller represents or interacts with a modem, a keyboard, a mouse, a touchscreen, or a similar device. In some cases, the I/O controller is implemented as a component of a processor. In some cases, a user interacts with the device 1300 via the I/O component 1350 or via one or more hardware components controlled by the I/O controller.

The user interface component 1360 enables a user to interact with the device 1300 (e.g., via the I/O component 1350). In some cases, the user interface component 1360 includes an audio device, such as an external speaker system, an external display device such as a display screen, an input device (e.g., a remote-control device interfaced with a user interface directly or through the I/O controller), or a combination thereof. In some cases, the user interface component 1360 includes a graphical user interface.

In some aspects, the device 1300 performs one or more operations or processes described herein. For example, a non-transitory computer-readable medium (e.g., memory 1330) may store a set of instructions (e.g., one or more instructions or code) for execution by the processor 1320. The processor 1320 may execute the set of instructions to perform one or more operations or processes described herein. In some aspects, execution of the set of instructions, by one or more processors 1320, causes the one or more processors 1320 and/or the device 1300 to perform one or more operations or processes described herein. In some aspects, hardwired circuitry is used instead of or in combination with the instructions to perform one or more operations or processes described herein. Additionally, or alternatively, the processor 1320 may be configured to perform one or more operations or processes described herein. Thus, aspects described herein are not limited to any specific combination of hardware circuitry and software.

The number and arrangement of components shown in FIG. 13 are provided as an example. The device 1300 may include additional components, fewer components, different components, or differently arranged components than those shown in FIG. 13. Additionally, or alternatively, one or more components of the device 1300 may perform one or more functions described as being performed by another set of components of the device 1300.

FIG. 14 is a diagram illustrating an example video generation apparatus 1400 configured to use a diffusion model associated with a synchronized coupled sampling framework to generate a video from an input prompt, according to some aspects of the present disclosure. In some aspects, the video generation apparatus 1400 includes or implements aspects associated with the video generation device shown and described with reference to FIG. 1, the guided diffusion model shown and described with reference to FIG. 2, the U-Net shown and described with reference to FIG. 3, the examples shown and described with reference to FIGS. 8-9, the user device 1010 and/or the server 1020 shown and described with reference to FIG. 10, and/or the device 1300 or one or more components of the device 1300 shown and described with reference to FIG. 14. As shown in FIG. 14, the video generation apparatus 1400 includes a processor unit 1405, a memory unit 1410, an I/O component 1420, and a training component 1425. The training component 1425 updates parameters of a diffusion model 1415 stored in the memory unit 1410. In some examples, the training component 1425 is located outside the video generation apparatus 1400.

The processor unit 1405 includes one or more processors. A processor is an intelligent hardware device, such as a general-purpose processing component, a digital signal processor (DSP), a central processing unit (CPU), a graphics processing unit (GPU), a microcontroller, an application specific integrated circuit (ASIC), a field programmable gate array (FPGA), a programmable logic device, a discrete gate or transistor logic component, a discrete hardware component, or any combination thereof. In some cases, the processor unit 1405 is configured to operate a memory array using a memory controller. In other cases, a memory controller is integrated into the processor unit 1405. In some cases, the processor unit 1405 is configured to execute computer-readable instructions stored in the memory unit 1410 to perform various functions. In some aspects, the processor unit 1405 includes special purpose components for modem processing, baseband processing, digital signal processing, or transmission processing. According to some aspects, the processor unit 1405 comprises one or more processors 1320 described with reference to FIG. 13.

The memory unit 1410 includes one or more memory devices. Examples of a memory device include random access memory (RAM), read-only memory (ROM), or a hard disk. Examples of memory devices include solid state memory and a hard disk drive. In some examples, memory is used to store computer-readable, computer-executable software including instructions that, when executed, cause at least one processor of the processor unit 1405 to perform various functions described herein.

In some cases, the memory unit 1410 includes a basic input/output system (BIOS) that controls basic hardware or software operations, such as an interaction with peripheral components or devices. In some cases, the memory unit 1410 includes a memory controller that operates memory cells of the memory unit 1410. For example, the memory controller may include a row decoder, column decoder, or both. In some cases, the memory cells within the memory unit 1410 store information in the form of a logical state. According to some aspects, the memory unit 1410 is an example of the memory 1330 described with reference to FIG. 13.

According to some aspects, the video generation apparatus 1400 uses one or more processors of the processor unit 1405 to execute instructions stored in the memory unit 1410 to perform functions described herein. For example, the video generation apparatus 1400 may configure and/or use the diffusion model 1415 to generate a video that has diverse changes controlled or guided by the input prompt, seamless and smooth transitions, and long-term contextual consistency throughout the video.

The I/O component 1420 receives inputs from and transmits outputs of the video generation apparatus 1400 to other devices or users. For example, the I/O component 1420 receives inputs corresponding to one or more input prompts describing a video to be generated and transmits outputs corresponding to a video that has diverse changes, seamless and smooth transitions, and long-term contextual consistency throughout the video, controlled or guided by the one or more input prompts. According to some aspects, the I/O component 1420 is an example of the I/O component 1350 described with reference to FIG. 13.

In some aspects, as described herein, the video generation apparatus 1400 receives an input video associated with one or more text prompts; performs, using a machine learning model (e.g., diffusion model 1415), one or more forward diffusion operations on the input video to generate an intermediate output based on the one or more text prompts associated with the input video and similarities among one or more segments of the input video; and performing, using the machine learning model (e.g., diffusion model 1415), a reverse diffusion operation on the intermediate output to generate an output video associated with the one or more text prompts.

Additionally, or alternatively, the video generation apparatus 1400 receives an input video associated with one or more text prompts; performs, using a machine learning model (e.g., diffusion model 1415), a first forward diffusion operation based on the one or more text prompts associated with the input video; performs, using the machine learning model (e.g., diffusion model 1415), a second forward diffusion operation based on inter-sample consistency in an output of the first forward diffusion operation; and outputs, by the machine learning model (e.g., diffusion model 1415), an output video based on the first forward diffusion operation and the second forward diffusion operation.

In some embodiments, the diffusion model 1415 is an artificial neural network (ANN) such as the guided diffusion model described with reference to FIG. 2 and the U-Net described with reference to FIG. 3. An ANN can be a hardware component or a software component that includes connected nodes (e.g., artificial neurons) that loosely correspond to the neurons in a human brain. Each connection, or edge, transmits a signal from one node to another (like the physical synapses in a brain). When a node receives a signal, it processes the signal and then transmits the processed signal to other connected nodes.

ANNs have numerous parameters, including weights and biases associated with each neuron in the network, which control the degree of connection between neurons and influence the neural network's ability to capture complex patterns in data. These parameters, also known as model parameters or model weights, are variables that determine the behavior and characteristics of a machine learning model.

In some cases, the signals between nodes comprise real numbers, and the output of each node is computed by a function of its inputs. For example, nodes may determine their output using other mathematical algorithms, such as selecting the max from the inputs as the output, or any other suitable algorithm for activating the node. Each node and edge are associated with one or more node weights that determine how the signal is processed and transmitted. In some cases, nodes have a threshold below which a signal is not transmitted at all. In some examples, the nodes are aggregated into layers.

The parameters of the diffusion model 1415 can be organized into layers. Different layers perform different transformations on their inputs. The initial layer is known as the input layer and the last layer is known as the output layer. In some cases, signals traverse certain layers multiple times. A hidden (or intermediate) layer includes hidden nodes and is located between an input layer and an output layer. Hidden layers perform nonlinear transformations of inputs entered into the network. Each hidden layer is trained to produce a defined output that contributes to a joint output of the output layer of the ANN. Hidden representations are machine-readable data representations of an input that are learned from hidden layers of the ANN and are produced by the output layer. As the understanding of the ANN of the input improves as the ANN is trained, the hidden representation is progressively differentiated from earlier iterations.

The training component 1425 may train the diffusion model 1415. For example, parameters of the diffusion model 1415 can be learned or estimated from training data and then used to make predictions or perform tasks based on learned patterns and relationships in the data. In some examples, the parameters are adjusted during the training process to minimize a loss function or maximize a performance metric (e.g., as described with reference to FIG. 6 and FIG. 7). The goal of the training process may be to find optimal values for the parameters that allow the machine learning model to make accurate predictions or perform well on the given task. Accordingly, the node weights can be adjusted to improve the accuracy of the output (e.g., by minimizing a loss which corresponds in some way to the difference between the current result and the target result). The weight of an edge increases or decreases the strength of the signal transmitted between nodes. For example, during the training process, an algorithm adjusts machine learning parameters to minimize an error or loss between predicted outputs and actual targets according to optimization techniques like gradient descent, stochastic gradient descent, or other optimization algorithms. Once the machine learning parameters are learned from the training data, the diffusion model 1415 can be used to make predictions on new, unseen data (e.g., during inference).

The number and arrangement of components shown in FIG. 14 are provided as an example. The video generation apparatus 1400 may include additional components, fewer components, different components, or differently arranged components than those shown in FIG. 14. Additionally, or alternatively, one or more components of the video generation apparatus 1400 may perform one or more functions described as being performed by another set of components of the video generation apparatus 1400.

The foregoing disclosure provides illustration and description, but is not intended to be exhaustive or to limit the aspects to the precise forms disclosed. Modifications may be made in light of the above disclosure or may be acquired from practice of the disclosed aspects.

As used herein, the term “component” is intended to be broadly construed as hardware, firmware, or a combination of hardware and software. It will be apparent that systems and/or methods described herein may be implemented in different forms of hardware, firmware, and/or a combination of hardware and software. The actual specialized control hardware or software code used to implement these systems and/or methods is not limiting of the aspects described herein. Thus, the operation and behavior of the systems and/or methods are described herein without reference to specific software code—it being understood that software and hardware can be used to implement the systems and/or methods based on the description herein.

As used herein, satisfying a threshold may, depending on the context, refer to a value being greater than the threshold, greater than or equal to the threshold, less than the threshold, less than or equal to the threshold, equal to the threshold, not equal to the threshold, or the like.

Although particular combinations of features are recited in the claims and/or disclosed in the specification, these combinations are not intended to limit the disclosure of various aspects. In fact, many of these features may be combined in ways not specifically recited in the claims and/or disclosed in the specification. Although each dependent claim listed below may directly depend on only one claim, the disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiple of the same item.

When “a processor” or “one or more processors” (or another device or component, such as “a controller” or “one or more controllers”) is described or claimed (within a single claim or across multiple claims) as performing multiple operations or being configured to perform multiple operations, this language is intended to broadly cover a variety of processor architectures and environments. For example, unless explicitly claimed otherwise (e.g., via the use of “first processor” and “second processor” or other language that differentiates processors in the claims), this language is intended to cover a single processor performing or being configured to perform all of the operations, a group of processors collectively performing or being configured to perform all of the operations, a first processor performing or being configured to perform a first operation and a second processor performing or being configured to perform a second operation, or any combination of processors performing or being configured to perform the operations. For example, when a claim has the form “one or more processors configured to: perform X; perform Y; and perform Z,” that claim should be interpreted to mean “one or more processors configured to perform X; one or more (possibly different) processors configured to perform Y; and one or more (also possibly different) processors configured to perform Z.”

No element, act, or instruction used herein should be construed as critical or essential unless explicitly described as such. Also, as used herein, the articles “a” and “an” are intended to include one or more items, and may be used interchangeably with “one or more.” Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, or a combination of related and unrelated items), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A method comprising:
receiving one or more text prompts;
receiving an input video associated with the one or more text prompts;
performing, using a machine learning model, one or more forward diffusion operations on the input video to generate an intermediate output based on the one or more text prompts associated with the input video and similarities among one or more segments of the input video; and
performing, using the machine learning model, a reverse diffusion operation on the intermediate output to generate an output video associated with the one or more text prompts.

2. The method of claim 1, wherein the one or more forward diffusion operations include a first forward diffusion operation and a second forward diffusion operation, and wherein the first forward diffusion operation and the reverse diffusion operation are associated with a denoise diffusion implicit model (DDIM) update operation for the input video.

3. The method of claim 2, wherein the second forward diffusion operation is performed during the DDIM update operation.

4. The method of claim 2, wherein the first forward diffusion operation and the second forward diffusion operation are associated with a fixed timestep based on a schedule associated with the DDIM update operation.

5. The method of claim 1, wherein performing the one or more forward diffusion operations includes:
generating, using the machine learning model, the intermediate output based on the one or more text prompts;
dividing the intermediate output into overlapping segments;
sampling the one or more segments from the overlapping segments of the intermediate output;
determining, using the machine learning model and for each segment of the one or more segments, a respective score based on an inter-sample similarity among adjacent segments and distant segments among the one or more segments sampled from the intermediate output; and
performing, using the machine learning model, a fusion operation on the overlapping segments of the intermediate output to refine the intermediate output according to the respective score for each segment of the one or more segments sampled from the intermediate output.

6. The method of claim 5, wherein performing the one or more forward diffusion operations further includes:
configuring a baseline noise associated with the one or more forward diffusion operations, wherein each segment in the one or more segments sampled from the intermediate output is associated with a respective portion of the baseline noise.

7. The method of claim 1, wherein the one or more forward diffusion operations include a first forward diffusion operation performed in a first quantity of iterations and a second forward diffusion operation performed in a second quantity of iterations that is less than the first quantity of iterations.

8. The method of claim 1, wherein the one or more text prompts include a global text prompt applicable to each segment of the input video and one or more local text prompts that are each applicable to a respective segment of the input video.

9. A system comprising:
a memory component; and
a processing device coupled to the memory component, the processing device to perform operations comprising:
receiving one or more text prompts;
receiving an input video associated with the one or more text prompts;
performing, using a machine learning model, a first forward diffusion operation based on the one or more text prompts associated with the input video;
performing, using the machine learning model, a second forward diffusion operation based on inter-sample consistency in an output of the first forward diffusion operation; and
outputting, by the machine learning model, an output video based on the first forward diffusion operation and the second forward diffusion operation.

10. The system of claim 9, wherein the first forward diffusion operation is associated with a denoise diffusion implicit model (DDIM) update operation for the input video.

11. The system of claim 10, wherein the second forward diffusion operation is performed during the DDIM update operation.

12. The system of claim 10, wherein the first forward diffusion operation and the second forward diffusion operation are associated with a fixed timestep based on a schedule associated with the DDIM update operation.

13. The system of claim 9, wherein performing the second forward diffusion operation includes:
dividing the output of the first forward diffusion operation into overlapping segments;
sampling a subset of the overlapping segments;
determining, using the machine learning model and for each segment of the subset of the overlapping segments, a respective score based on an inter-sample similarity among adjacent segments and distant segments in the subset of the overlapping segments; and
performing, using the machine learning model, a fusion operation on the overlapping segments of the output of the first forward diffusion operation to refine the output of the first forward diffusion operation according to the respective score for each segment of the subset of the overlapping segments.

14. The system of claim 9, wherein the first forward diffusion operation is performed in a first quantity of iterations and the second forward diffusion operation is performed in a second quantity of iterations that is less than the first quantity of iterations.

15. The system of claim 9, wherein the one or more text prompts include a global text prompt applicable to each segment of the input video and one or more local text prompts that are each applicable to a respective segment of the input video.

16. A non-transitory computer-readable medium storing executable instructions, which when executed by a processing device, cause the processing device to perform operations comprising:
receiving one or more text prompts;
receiving an input video associated with the one or more text prompts;
performing, using a machine learning model, one or more forward diffusion operations on the input video to generate an intermediate output based on the one or more text prompts associated with the input video and similarities among one or more segments of the input video; and
performing, using the machine learning model, a reverse diffusion operation on the intermediate output to generate an output video associated with the one or more text prompts.

17. The non-transitory computer-readable of claim 16, wherein the one or more forward diffusion operations include a first forward diffusion operation and a second forward diffusion operation, and wherein the first forward diffusion operation and the reverse diffusion operation are associated with a denoise diffusion implicit model (DDIM) update operation for the input video.

18. The non-transitory computer-readable of claim 17, wherein the second forward diffusion operation is performed during the DDIM update operation.

19. The non-transitory computer-readable of claim 16, wherein performing the one or more forward diffusion operations includes:
generating, using the machine learning model, the intermediate output based on the one or more text prompts;
dividing the intermediate output into overlapping segments;
sampling the one or more segments from the overlapping segments of the intermediate output;
determining, using the machine learning model and for each segment of the one or more segments, a respective score based on an inter-sample similarity among adjacent segments and distant segments among the one or more segments sampled from the intermediate output; and
performing, using the machine learning model, a fusion operation on the overlapping segments of the intermediate output to refine the intermediate output according to the respective score for each segment of the one or more segments sampled from the intermediate output.

20. The non-transitory computer-readable of claim 16, wherein the one or more text prompts include a global text prompt applicable to each segment of the input video and one or more local text prompts that are each applicable to a respective segment of the input video.
